(19) United States
(12) Patent Application Publication
(10) Pub. No.: US 2007/0150246 A1
(43) Pub. Date: Jun. 28, 2007

(54) Context-Supported Structures in a Modeling Language

(75) Inventors: Bassam Tabbara, Seattle, WA (US); Geoffrey H. Outhred, Seattle, WA (US); Kevin D.J. Grealish, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/275,371

(22) Filed: Dec. 28, 2005

(51) Int. Cl. G06G 7/48; G06G 7/58

(52) U.S. Cl. 703/11

(57) ABSTRACT

The present modeling technique allows context to be associated with structural elements. These structural elements are defined within a containing class (i.e., a context-supported class). Thus, knowledge that is captured about complex internal behavior of the structural elements (e.g., constraints) may be incorporated within the context-supported class without requiring business logic. The context-supported structure includes one or more parts associated with the context-supported structure through relationships. The context-supported structure may also include one or more connectors associated with the context-supported structure. The connectors connect two types of classes together to enforce a specific constraint. The two types of classes may be parts associated with the context-supported structure or other classes that are not part of the context-supported structure.

### BACKGROUND

Modeling technologies are used to graphically illustrate complex systems. There are many well-known modeling technologies, such as Uniform Modeling Language (UML), Entity-Relationship diagrams, object-relational mapping, and the like. Typically, the modeling technology uses a notation language to create a visual representation (i.e., modeling diagram) of the complex system. The modeling technology may also use a graphical interface to create the modeling diagram.

In general, modeling technologies represent the system being modeled using objects, where each object may be associated with a set of properties. The model then represents the relationships between the objects and their respective properties. The objects may be referred to as entities (entity-relationship diagrams), classes (object-relational mapping), or the like.

For example, FIG. 1 illustrates a modeling diagram for motorized vehicles using UML notation. From the modeling diagram 100, one can see that a motorized vehicle 110 is associated with two other parts: a wheel 120 and an engine 130. There is a wheel relationship 140 (denoted with a “w”) and an engine relationship 150 (denoted with an “e”). Specifically, the w relationship constrains each motorized vehicle to having zero or more wheels where each wheel belongs to exactly one motorized vehicle. Thus, the w relationship is a 1:* relationship. Likewise, the e relationship constrains each motorized vehicle to having zero or more engines where each engine belongs to exactly one motorized vehicle. In addition to the w and e relationships, there is an axle relationship 160 (denoted as “Axle”) between the wheel and the engine parts. The axle relationship specifies that an engine may be connected to zero or more wheels through an axle and a wheel may be connected to zero or more engines through the axle. Using object-oriented concepts, the motorized vehicle, wheel, and engine may each be defined by a class.

When this motorized vehicle model 100 is used during processing, an instance of the MotorizedVehicle class may be created. This MotorizedVehicle instance may then be associated with any number of wheel instances (e.g., four wheel instances w1-w4) and any number of engine instances (e.g., one instance e1). The four wheel instances w1-4 may be connected to the engine instance e1 through an axle relationship a. Thus, this general model for a motorized vehicle can support many different types of motorized vehicles, such as motorbikes, trucks, automobiles, and the like.

If a more specific type of motorized vehicle needs to be modeled, the general motorized vehicle model 100 may be modified to accommodate the specific type of motorized vehicle. The modifications add complexity to the general model by adding additional constraints. For example, the model may be modified to support instances of single-engine front-wheel drive cars. This may be achieved by sub-typing one or more of the classes and adding relationships that constrain the general model. Each sub-typed class inherits from its parent class.

FIG. 2 illustrates the resulting single-engine front-wheel drive model diagram 200 after sub-typing. A Car class 212 is sub-typed from the MotorizedVehicle class 110. A FrontWheel class 222 and a RearWheel class 224 are sub-typed from the Wheel class 120. A CarEngine class 232 is sub-typed from the Engine class 130. A front wheel relationship 242 and a rear wheel relationship 244 are sub-typed from the wheel relationship 140, denoted as f:w and r:w in the model diagram, respectively. A car engine relationship 252 is sub-typed from the engine relationship 150, denoted as x:e in the model diagram. A front-wheel drive relationship 262 is sub-typed from the axle relationship 160 shown in FIG. 1, denoted as a: Axle in model diagram 200. Given these sub-types (i.e., constraints), the new model diagram 200 specifies that a car must have two front wheels and two rear wheels, one engine, and a car engine must drive two front wheels.

However, even with all this added complexity, model diagram 200 may still allow erroneous results. For example, an engine of one motorized vehicle may drive the front wheels of another motorized vehicle. Therefore, additional business logic must be layered on top of the general model to check the validity of the front-wheel drive relationship for each instance of a single engine front-wheel drive car. In so doing, the business logic and model become more complex. In addition, with each additional constraint, the business logic and model become even more complex. Therefore, it is desirable to have a modeling technique that does not incur the complexities illustrated and described above.

### SUMMARY

The present modeling technique allows context to be associated with structural elements. These structural elements are defined within the context of a containing class. Thus, knowledge that is captured about complex internal behavior of the structural elements may be incorporated within the class. The class and complex internal behavior may be declaratively defined to create a model without requiring business logic to be written.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a modeling diagram for a motorized vehicle shown using the well-known UML notation.

FIG. 2 is a model diagram for a single-engine front-wheel drive car derived from sub-typing the classes shown in FIG. 1, again using the well-known UML notation.

FIG. 3 is a model diagram for a single-engine front-wheel drive car using the present modeling notation that incorporates context into structural elements.

FIG. 4 is an illustrative computing device that may be used to implement the context-supported modeling technique described herein.

FIG. 5 is an exemplary model diagram illustrating aspects of the present modeling notation that incorporates context into structural elements.

FIG. 6 is a model diagram for a workstation based on the exemplary aspects shown in the model diagram of FIG. 5.

FIG. 7 is an exemplary syntax for declaratively defining the workstation modeled in FIG. 6 using one embodiment of the present modeling notation.

FIG. 8 is an enlarged view of a portion of the exemplary syntax which declaratively defines the composite structure in accordance with one embodiment of the present modeling technique.

FIG. 9 is a model diagram of a web server based on the exemplary aspects shown in FIG. 5 and illustrates the use of arbitrary relationship types in accordance with the present modeling technique.

FIGS. 10 and 11 illustrate an eShop Deployment context-supported structure built upon two other context-supported structures in accordance with the present modeling technique.

FIG. 12 is a model diagram that illustrates a part-less connector in accordance with the present modeling technique.

FIG. 13 is a flow diagram illustrating an overview of a process for defining a context-supported structure in accordance with the present modeling technique.

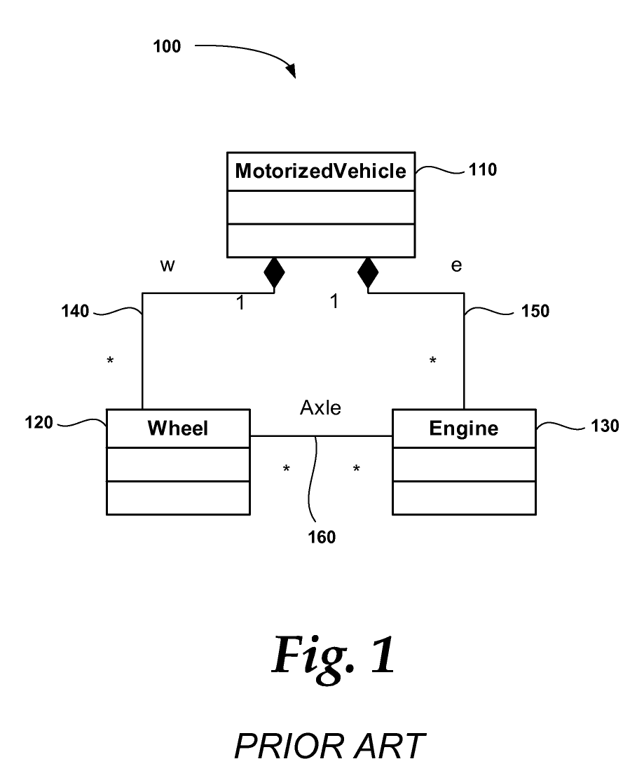

### DETAILED DESCRIPTION

The present modeling technique decreases the complexity of models and the amount of business logic required to ensure validation of constraints, by allowing the definition of a relationship within the context of a class. This allows a notion of context to be built into structured elements, thereby allowing structural elements with context within a containing class. Thus, constraints may be built into the containing class.

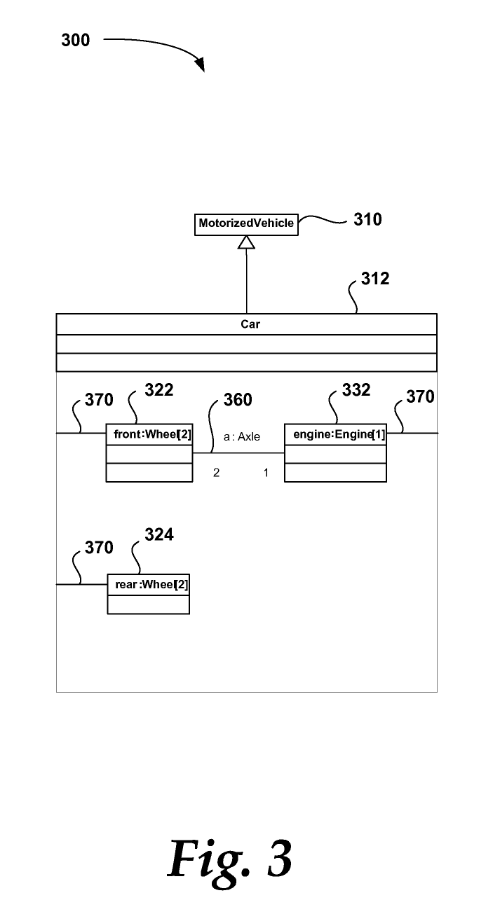

Returning to the modeling example for a single-engine front-wheel drive car, FIG. 3 is a model diagram using the present modeling notation that incorporates context-supported structures. As shown, there is a MotorizedVehicle class 310. A Car class 312 inherits from the MotorizedVehilce class 310. The Car class 312 is a composite class that incorporates context within the class in accordance with the present modeling technique. Thus, the Car class 312 is composed of three parts: front 322, rear 324, and engine 332. The front 322 and the rear 324 parts are data members of type Wheel class. The engine 332 part is a data member of type Engine class. The Car class 312 is also composed of one connector 360 (denoted as “a”). The connector 360 is a data member of type Axle relationship 160. In addition, there is a relationship 370 between each of the three parts and the Car class 312. As will be described in more detail below, relationship 370 allows context to be included for each part. For example, in the example illustrated in FIG. 3, every instance of the Car class includes two instances of the front wheel, two instances of the rear wheel, and one instance of the single engine. The notation for the number of instances for each part is indicated by a number within brackets after the name of the part. In addition, each instance of the Car class includes an instance of connector “a” that is between the two instances of the front wheels and the one instance of the single engine.

As shown, the parts and connectors belong to the internal structure of the composite class Car 312, meaning that the parts and connectors are defined in the context of the class Car. As will be described, this allows details to be specified for instances of the front wheel, rear wheel, and connector “a” within the context of the class Car. These details are not global details for wheels and engines in general. In addition, as will be described, the present modeling technique ensures that instances of the parts and connectors are linked if they are both members of the same instance of the class Car. Thus, the problem with having an instance of one car's front wheels having an axle relationship with an instance of another car's engine is overcome without requiring business logic to ensure this constraint is valid.

As will be shown, using composite structures, classes with fairly complex internal behavior may be defined. In addition, the knowledge captured within the composite structures may be defined in a declarative manner. This allows authoring tools to create models on the fly and to enforce the rules at runtime, thereby automating the process of creating models and processing the created models.

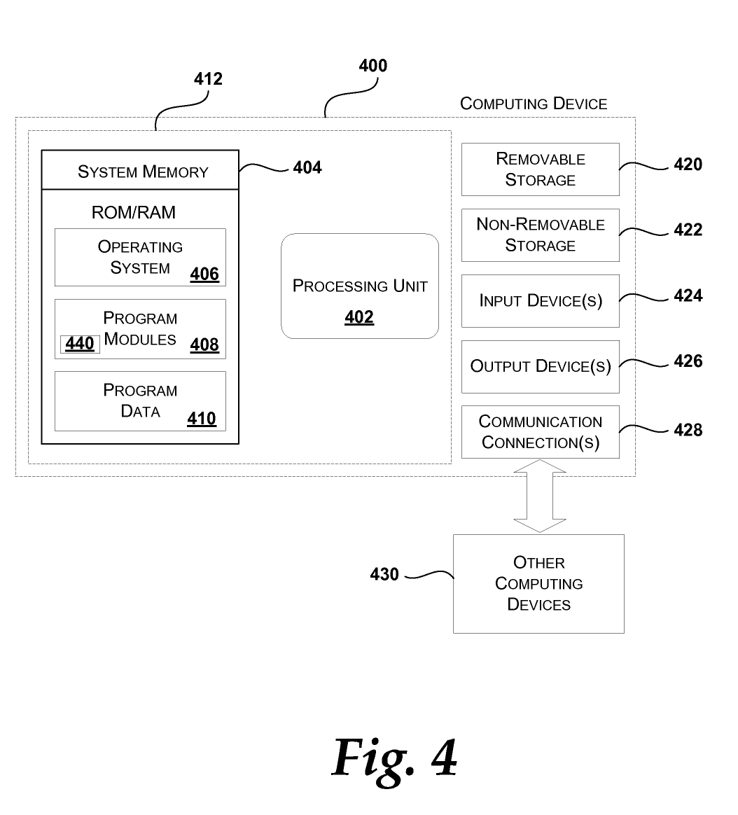

FIG. 4 is an illustrative computing device that may be used to implement the present modeling technique described herein. The system includes a computing device, such as computing device 400. In a very basic configuration, computing device 400 typically includes at least one processing unit 402 and system memory 404. Depending on the exact configuration and type of computing device, system memory 404 may be volatile (such as RAM), non-volatile (such as ROM, flash memory, etc.) or some combination of the two. System memory 404 typically includes an operating system 406, one or more program modules 408, and may include program data 410. For the present modeling technique, the program modules 408 may include one or more components 440 for implementing the modeling technique. Alternatively, the operating system 406 may include one or more components for implementing the modeling technique. This basic configuration is illustrated in FIG. 4 by those components within dashed line 412.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by removable storage 420 and non-removable storage 422. Computer storage media may include volatile and nonvolatile, removable and non-removable media implemented in any method or technology for storage of information, such as computer readable instructions, data structures, program modules, or other data. System memory 404, removable storage 420 and non-removable storage 422 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of device 400. Computing device 400 may also have input device(s) 424 such as keyboard, mouse, pen, voice input device, touch input device, etc. Output device(s) 426 such as a display, speakers, printer, etc. may also be included. These devices are well know in the art and need not be discussed at length here.

Computing device 400 may also contain communication connections 428 that allow the device to communicate with other computing devices 430, such as over a network. Communication connection(s) 428 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media can be any available media that can be accessed by a computer. By way of example, and not limitation, computer readable media may comprise “computer storage media” and “communications media.”

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on or transmitted across some form of computer readable media.

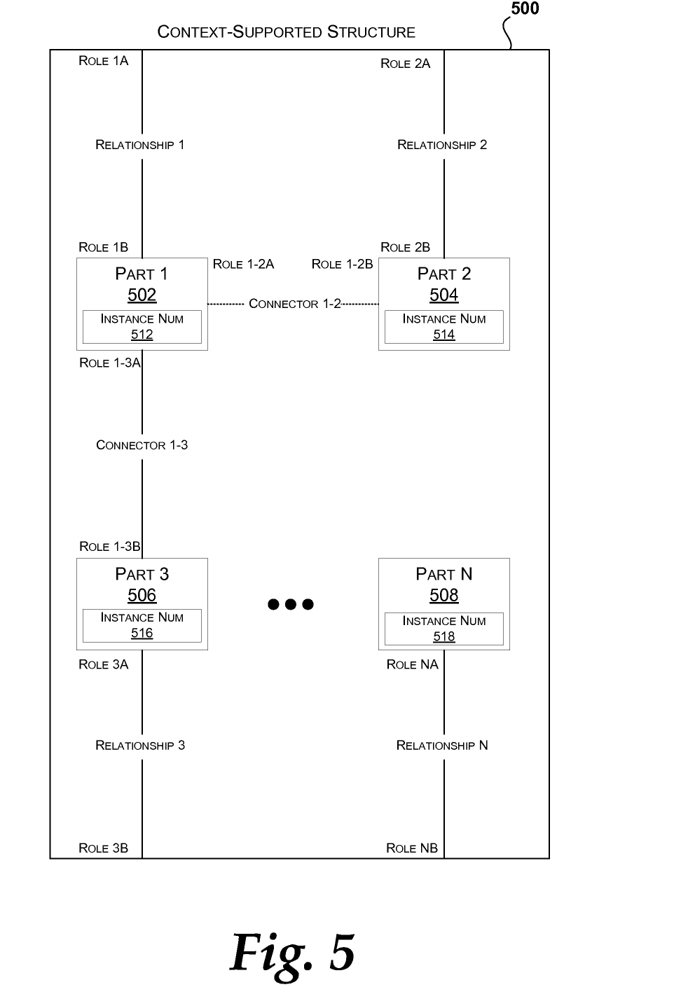

FIG. 5 is an exemplary model diagram illustrating aspects of the present modeling notation that incorporates context into structural elements in accordance with the present modeling technology. A context-supported structure 500 includes one or more parts 502-508 (e.g., Part 1, Part 2, Part 3, . . . Part N). Typically, each part is represented by a class which may be derived from another class. Each part may be associated with a relationship to the context-supported structure 500. For example, part 502 is associated with relationship 1 to the context-supported structure, as shown by the line from part 502 to the outer box representing the context-supported structure 500. The relationship includes two roles: a first role (e.g., Role 1A) associated with the context-supported structure and a second role (e.g., Role 1B) associated with the part. For example, the first role may be a parent and the second role may be a child, the first role may be host and the second role may be a guest, or the like. The relationship may be one of several different relationship types. Each part may have a different relationship type to the context-supported structure 500.

Each part has an associated instance number (e.g., instance num 512) that defines how many instances of the part may be within the context-supported structure 500. Thus, Part 2 is associated with Relationship 2 having Role 2A and Role 2B and is associated with instance num 514. Likewise, Part 3 is associated with Relationship 3 having Role 3A and 3B and is associated with instance num 516. Part N is associated with Relationship N having Role NA and NB and is associated with instance num 518.

In addition, the context-supported structure 500 may have inter-part relationships or connectors (e.g., connector 1-2 and connector 1-3). Each connector is represented by a relationship and maps two roles of the relationship to the connected parts (e.g., connector 1-3 maps Role 1-3A to Part1 and Role 1-3B to Part3). Again, the relationship representing a connector may be one of several different relationship types.

The parts and connectors represent the internal structure of the context-supported structure 500. In one embodiment, the parts may actually represent anonymous connectors that connect the instance of context-supported structure 500 to the composed part. By defining parts and connectors as described above, constraints hold for one or more of the parts and the connector within the context of the context-supported structure 500, but do not hold for instances of the classes representing parts and instances of relationships representing connectors in general.

As will be described, by using the context-supported structure 500, knowledge about the structure (i.e., system) can be captured into a document. The document can then be processed by a software application to help in the decision process or be used by a software application to automatically make decisions based on the captured knowledge. The document that is created is referred to as the model. The context-supported structure 500 may be implemented within any modeling language, such as UML, System Definition Model (SDM), and the like. The structure allows the modeling language to capture a richer model by incorporating information about the environment, policies, and the like. As will be described below, a policy, constraint, or rule can be associated with this particular structure 500. Therefore, scoping for the policy, constraint, or rule can be applied without requiring business logic to be written for validating the policy, constraint, or rule within the current context.

In contrast, current modeling technologies require business logic to check the context and then apply the rule if the context is valid. This typically requires rather large rules to be written to check for various contexts. In addition to the burden of writing the complex business logic, the business logic also creates additional processing overhead when the rule is processed by an application.

The present modeling technique may be implemented to model numerous types of systems. The following discussion describes aspects of the modeling technique using one example scenario. The example scenario is of a system administrator working within a small business who plans to deploy a new application through-out the small business. The small business has workstations, desktops, and web servers. One web server hosts the small business's front end which shows the business's profile and other general information. Another web server hosts the applications that the small business uses. These web servers utilize different operating systems and software and are configured differently. The system administrator is knowledgeable of these differences and uses this knowledge when making modifications to them. The following discussion will now describe how the present context-supported structures help the system administrator in performing his tasks.

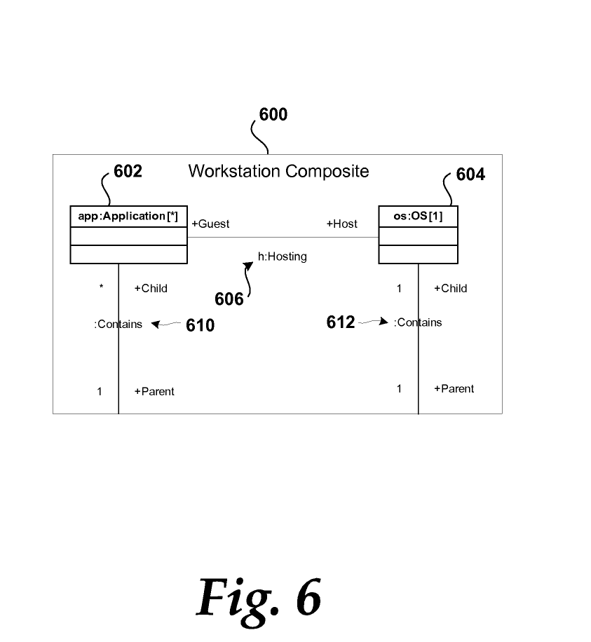

FIG. 6 is a model diagram for a workstation utilizing the concepts illustrated in the basic model diagram shown in FIG. 5. Model diagram 600 is for a workstation context-supported structure (e.g., workstation composite structure). Through-out the following discussion, the terms composite structure and context-supported structure are used inter-changeably to refer to a structure that allows context to be built into the structure. The model diagram 600 for the workstation composite structure includes two parts: an app 602 and an operating system (os) 604. App 602 is a type of Application and os 604 is a type of Operating System (OS). The workstation composite structure also includes a connector 606 (h) between app and os. Connector 606 is a type of Hosting relationship between Application and Operating System.

App 602 and os 604 both have a relationship 610 and 612, respectively, with workstation composite 600. Relationship 610 and 612 are both “Contains” relationships where the role of workstation is the “Parent” and the role of app 602 and os 604 is “Child”. According to the relationships 610 and 612, each instance of workstation 600 may have zero or more instances of part app 602 and may have one instance of part os 604. In addition, each instance of workstation must have an instance of connector h 606. The instance of connector h 606 defines each hosting relationship between one or more instances of part app 602 and the single instance of part os 604. Therefore, if workstation 600 does not have any instances of part app 602, the instance of connector h 606 will still exist but will not contain any instances of the hosting relationships.

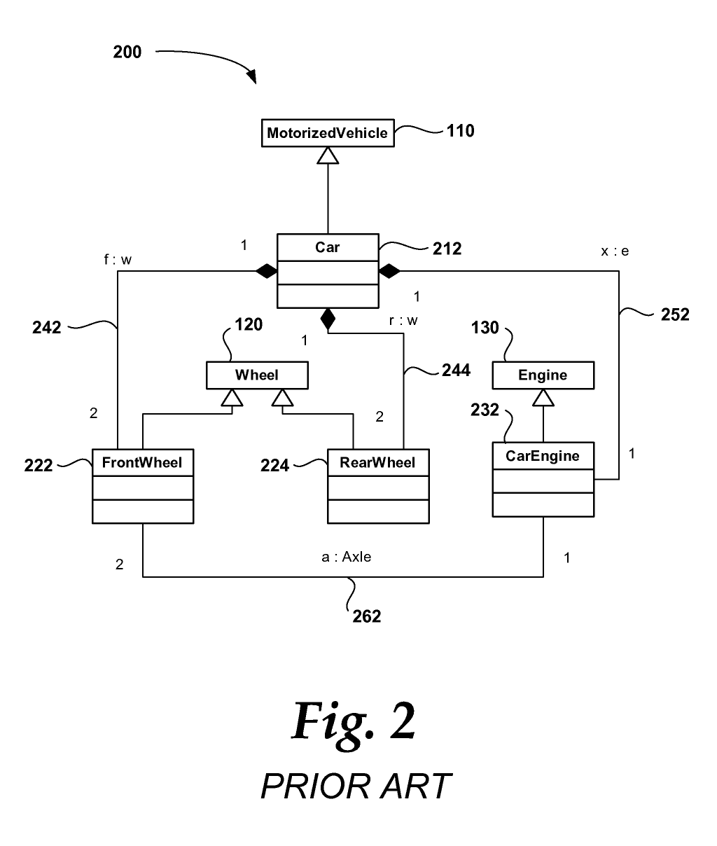

Connector h 606 specifies that for each hosting relationship between app 602 and os 604, app 602 plays the role as Guest and the single instance of os 604 plays the role as Host. Because the present modeling technique includes connector h, a constraint can be asserted to ensure all instances of app 602 belonging to a workstation instance are hosted on the instance of os 604 that is also part of the same workstation instance. Thus, by including connector h 606, the context problem explained above in conjunction with the single-engine front-wheel drive car model in FIG. 2 is overcome. In other words, the context is built into the structure so that an engine from a first car can not drive the front wheels of a second car.

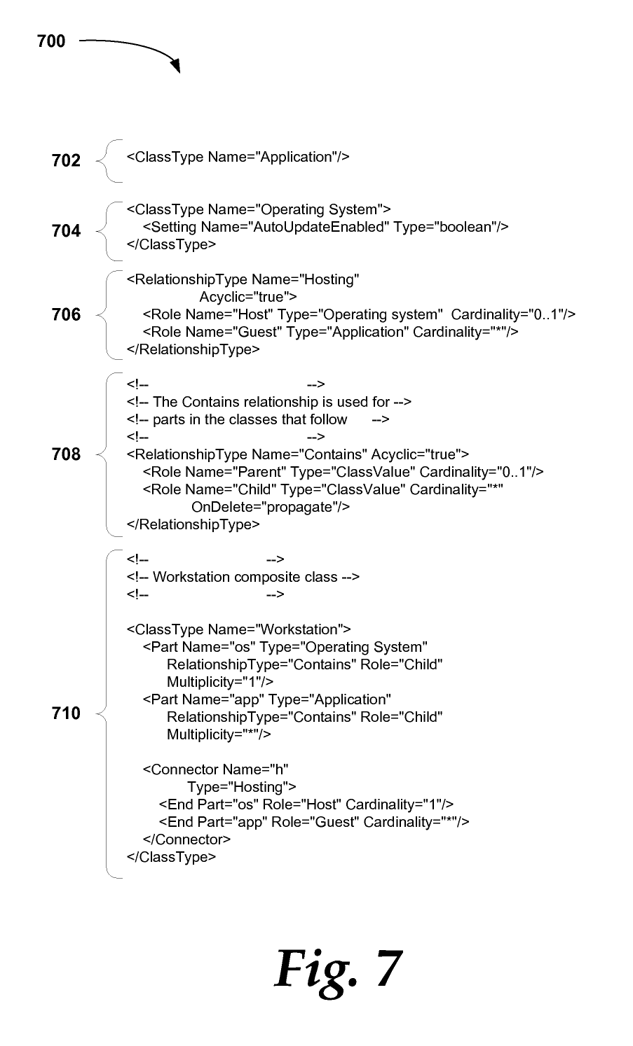

FIG. 7 is an exemplary syntax for declaratively defining the workstation modeled in FIG. 6 using one embodiment of the present modeling notation. For convenience in describing FIG. 7, the declarative syntax is broken into blocks with each block having one or more lines of text. Each of the blocks is then used in describing the context-supported structure.

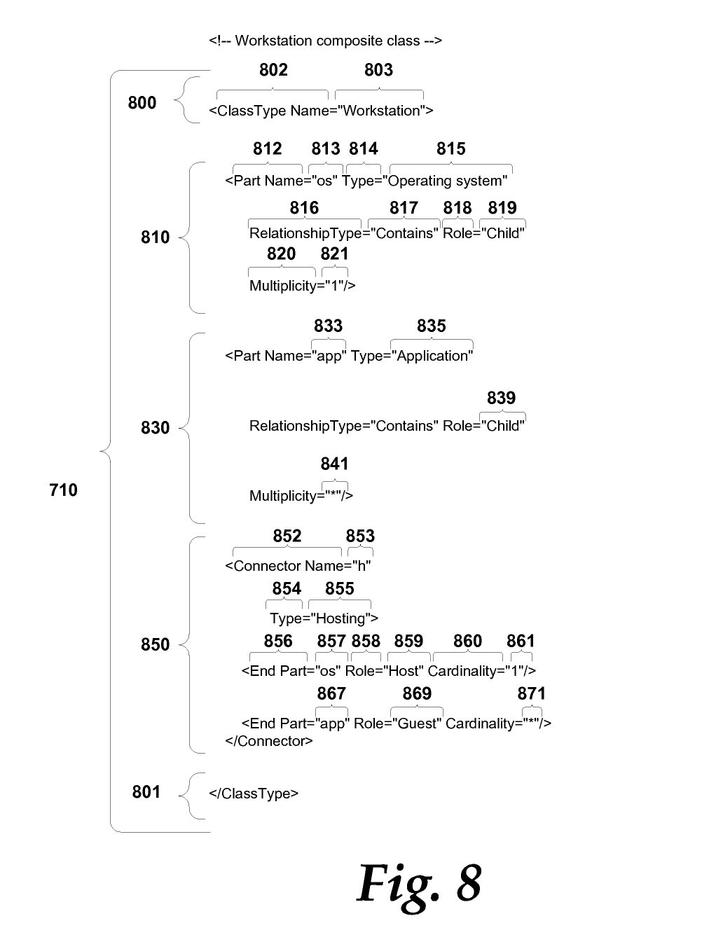

Blocks 702, 704, and 706, define classes and relationships. Block 708 defines a contains relationship. Block 710 defines a context-supported structure using the classes and relationships defined in blocks 702, 704, 706, and 708. FIG. 8 displays block 710 in an enlarged format to more conveniently illustrate certain syntax used in declaring the context-supported structure.

Block 702 and 704, each define a class type, “Application” and “Operating System”, respectively. Block 704 further defines a Boolean property named “AutoUpdateEnabled”. Block 706 defines a relationship named “Hosting” that has a Host role filled by an Operating System instance and a Guest role filled by an Application instance. The Hosting relationship allows multiple guests and at most one host.

Block 708 defines a relationship named “Contains” that has two roles: Parent and Child. Both roles are filled by instances of a class named “ClassValue” where ClassValue is assumed to be the root base class of all classes. This “Contains” relationship binds the parts in the context-supported structure to the context-supported structure so that context (e.g., constraints) can be embedded within the structure itself without requiring business logic.

Block 710 defines the context-supported structure using the classes and relationships defined in blocks 702-708. For convenience, block 710 will be described using FIG. 8 which is an enlarged view of block 710. As shown in FIG. 8, block 710 is further divided into smaller blocks 800, 810, 830, and 850 of text. Each of these smaller blocks includes one or more tags where each tag is associated with some data. For convenience, the tags are referenced using even numbers and the data associated with each tag is referenced using the next consecutive number which is an odd number. Thus, the tags are illustrated once, but the different data associated with each tag are each illustrated.

Block 800 defines a class type tag 802 (e.g., “Class Type Name”) that is associated with data 803 which names the class (e.g., “Workstation”). The declaration for the defined class type continues until end marker 801. As was shown in FIG. 6, the workstation composite class includes two parts: an os and an app. These parts are defined in Blocks 810 and 830, respectively. Blocks 810 and 830 include a part name tag 812 associated with part name data 813 and 833, respectively. The part name data associates a name for the part that is included within the composite class. By including a part name tag 812, the class defined in block 800 becomes a composite class.

The part definitions 810 and 830 may also includes a type tag 814, a relationship type tag 816, a role tag 818, and a multiplicity tag 820. The type tag 814 is associated with type data (e.g., type data 815 and 833). The type data defines the part as a type of class, such as “Operating system” class, “Application” class, or the like. The relationship type tag 816 is associated with data 817 that defines the type of relationship. For parts in the composite structure, the type of relationship may be a “Contains” relationship as defined in block 708 in FIG. 7. This “Contains” relationship associates each instance of this part to a specific instance of the composite class. However, data 817 may also specify a relationship other than a “Contains” relationship. The role tag 818 is associated with role data (e.g., role data 819 and 833), where the role data may specify various types of roles. The multiplicity tag 820 is associated with multiplicity data (e.g., multiplicity data 821 and 841). The multiplicity data defines how many instances (e.g., the instance number 512 shown in FIG. 5) of the part may be associated with one instance of the composite class.

Block 850 defines connectors and includes a connector name tag 852, a type tag 854, and two end parts 856. The connector name tag 852 is associated with data 853 that provides a name for the defined connector. The type tag 854 is associated with data 855 that defines the type of connector relationship, such as “Hosting”. The end part tag 856 is associated with part data (e.g., part data 857 and 867). The part data defines the type of part connected to one end of the connector. The part data may be associated with a role tag 858 and cardinality tag 860. The role tag is associated with role data (e.g., role data 859 and 869) that defines the role for the particular end of the connector. The cardinality tag 860 is associated with cardinality data (e.g., cardinality data 861 and 871) that defines how many instances of the end part may be associated with the connector.

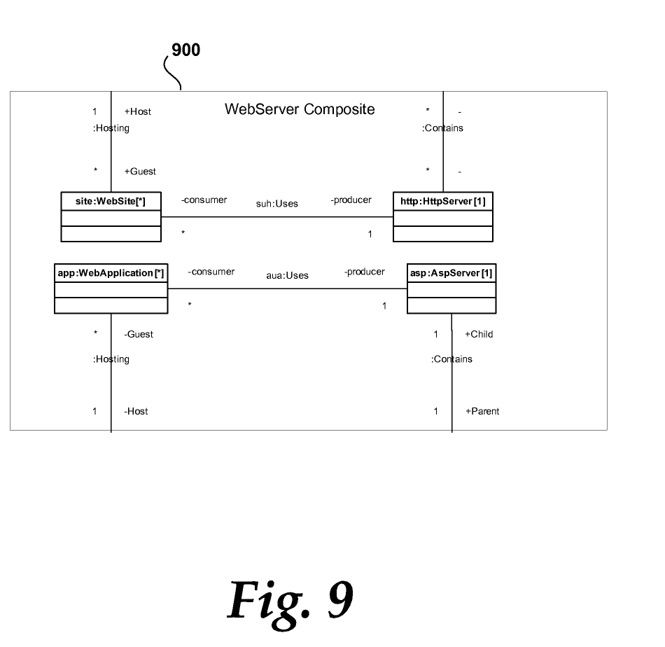

While the above syntax 800 defines the workstation illustrated in FIG. 6, one skilled in the art will appreciate that similar syntax can be used to define the workstation and other composite classes. FIGS. 9-12 illustrate other variations for context-supported structures using concepts illustrated and described in conjunction with FIG. 5. Each of these figures will now be briefly described.

FIG. 9 is a model diagram of a web server based on the concepts illustrated in the exemplary model diagram shown in FIG. 5. Model diagram 900 illustrates the use of arbitrary relationship types in accordance with the present modeling technique. This is in contrast with current modeling technologies that require the exclusive use of a containment relationship where instances of a part are exclusively contained in an instance of the composite type and their life-time is dependent on the life-time of the composite's instance. Model diagram 900 illustrates a webserver composite structure that has four parts: http, asp, app, and site. The parts http and asp are associated with the webserver composite structure through a “Contains” relationship. For part asp, the asp part plays the role of “Child” and the webserver composite plays the role of “Parent”. The part site and part app are associated with the webserver composite structure through a “Hosting” relationship where each part plays the role of “Guest” and the webserver composite plays the role of “Host”. The webserver composite structure also includes two named connectors: suh and aua. Both suh and aua are of a type “Uses” with a consumer as one role and a producer as another role. The suh connector captures the fact that instances of the site part must use the instance of the http part. The aua connector captures the fact that instances of the app part must use the instance of the asp part. Therefore, the suh and aua connectors provide context for the proper operation of the webserver without requiring business logic to be written.

The present modeling technology also allows new composite types to be built upon existing composite types. In addition, a new composite type can define one or more new connectors that may connect a part of the new composite type to a part of the existing composite type that is being used to define the new composite type or may connects parts of two different composite types that are being used to define the new composite type.

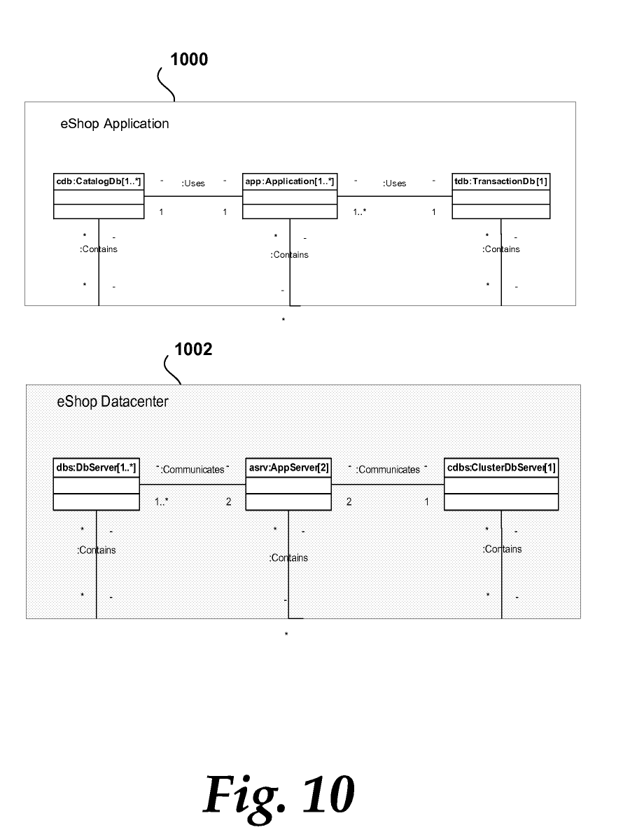

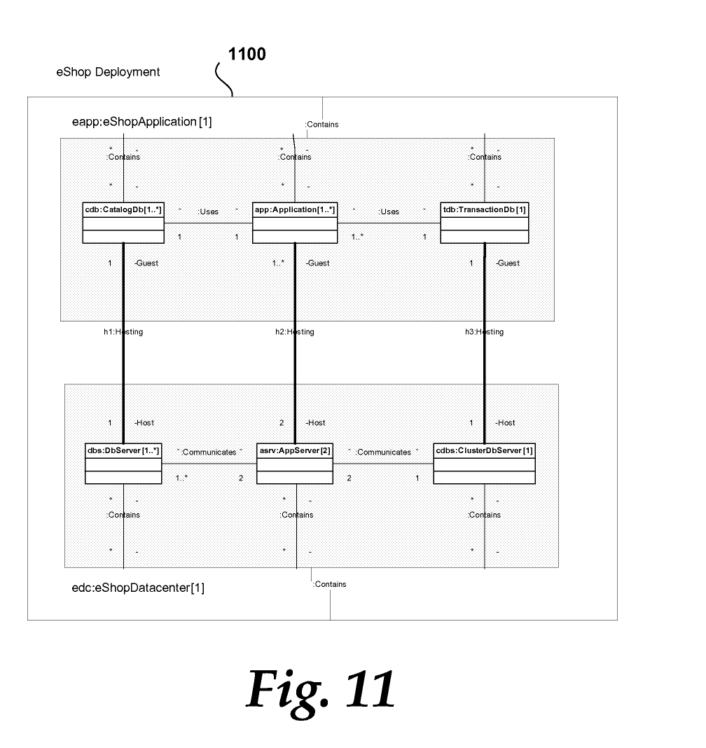

FIGS. 10 and 11 illustrate an example of a composite type (e.g., eShop Deployment 1100) being built using existing composite types (e.g., eShop Application 1000 and eShop Datacenter 1002). As shown in FIG. 11, composite type eShop Deployment 1100 includes a part named eapp, a part named edc, and three connectors: h1, h2, and h3. The eapp part is a single instance of an eShopApplication composite type illustrated in FIG. 10. The edc part is a single instance of eShopDatacenter composite type illustrated in FIG. 10. Connector h1 is a hosting relationship between an instance of a cdb sub-part in the eapp part and an instance of a dbs sub-part in the edc part. Connector h2 is a hosting relationship between an instance of an app sub-part in the eapp part and an instance of an asrv sub-part in the ecd part. Connector h3 is a hosting relationship between an instance of an tdb sub-part in the eapp part and an instance of a cdbs sub-part in the edc part. Thus, as shown and described, context-supported structures may be built from other context-supported structures.

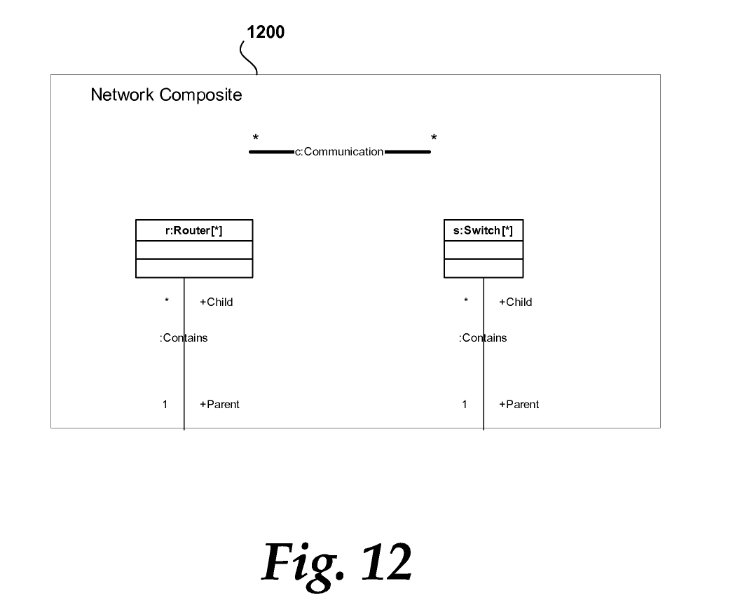

FIG. 12 is a model diagram that illustrates a part-less connector in accordance with the present modeling technique. Network composite class 1200 includes two parts (i.e., router and switch) and a connector c. The connector c is within the network composite type, but is not connected to any of the parts within the network composite type. Connector c is a communication relationship that has two roles: client and server. Both the client and the server are of a type computer. Connector c enforces the constraint that a network allows computers to communicate with each other. Thus, c is a part-less connector because the network composite type has no part of type computer.

Each connector c may have multiple instances of the communication relationship. Each instance of the communication relationship is between the two instances of the computer type, neither of which is composed by the instance of the network composite type. Even though connector c is a part-less connector in the network composite class, the network composite can still define constraints on the conector c. For example, the network composite class may define the quality of service, response time, or the like. The network composite class may also define constraints on the computer instances that can be connected by c even though the network composite class does not have a part composed of any instances of computer. In another embodiment, a semi part-less connector may be defined where one end of the connector is mapped to a part of the composite type and the other end is not mapped to any part of the composite type.

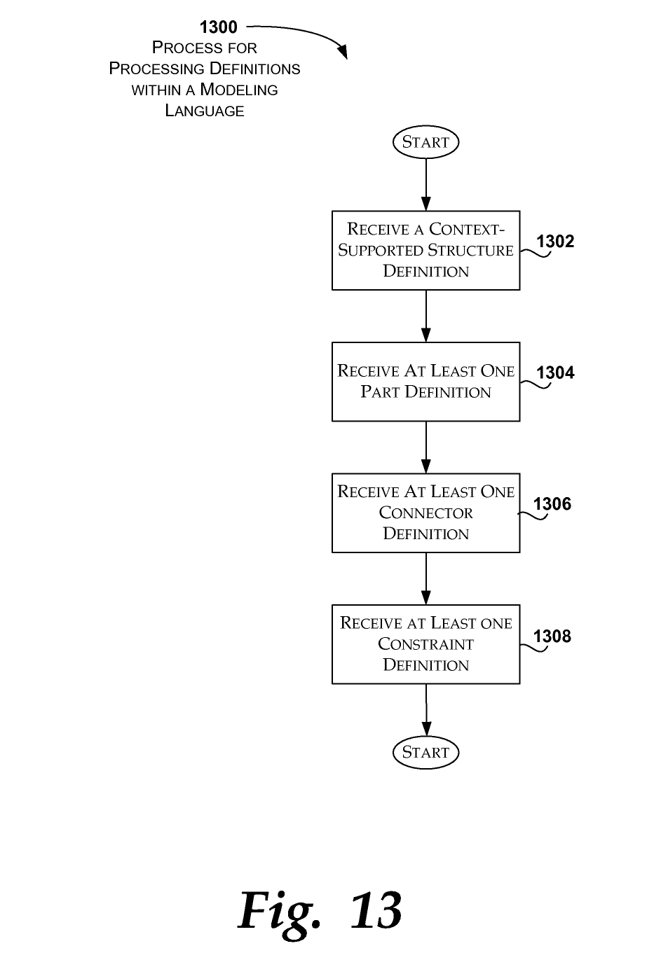

FIG. 13 is a flow diagram illustrating an overview of a process for processing definitions within a modeling language in accordance with the present modeling technique. Processing begins at block 1302 where a modeling file, such as the modeling file shown in FIG. 7, has been created and is being input for processing. At block 1302, a context-supported structure definition is received and processed to create an instance of a context-supported structure. Processing continues at block 1304.

At block 1304, at least one part definition is received. For each part definition that is received, an instance of a part is created and becomes associated with the context-supported structure. Processing continues at block 1306.

At block 1306, at least one connector definition is retrieved. For each connector definition that is received, an instance of a connector is created and becomes associated with the context-supported structure. Processing continues at block 1308.

At block 1308, at least one constraint definition is retrieved. The constraint definition defines the constraints associated with the context-supported structure. The constraint definitions are defined via the part definitions and/or the connector definitions, such as blocks 810, 830 and 850 shown in FIG. 8. These constraint definitions support the notion of context for the context-supported structure. Thus, the constraints (i.e., policies) can be defined for specific types of classes. Thus, the constraint may not apply to all instance of a class, but may only apply to certain instances that are within the associated context-supported class (i.e. a composite class), such as the composite class defined in block 800.

As described, the present modeling technology allows a context-supported structure to be declaratively defined with any arbitrary number of parts and connectors. The parts may each have distinct types or some parts may have the same type. Likewise, the connectors may each have a distinct type or may have the same type.

By using the present context-supported structures in a modeling language, a system administrator may download a generalized model and modify the model by adding his knowledge into a composite structure. Because this knowledge can be defined declaratively, tools can be deployed to automate the process. The present context-supported structure may be implemented within any modeling technology, such as system definition model (SDM) and others.

While example embodiments and applications have been illustrated and described, it is to be understood that the invention is not limited to the precise configurations and resources described above. For example, various aspects of the present modeling technology were illustrated and described in relation to system management. However, one skilled in the art will appreciate that context-supported structures may be utilized to model various systems. Various modifications, changes, and variations apparent to those skilled in the art may be made in the arrangement, operation, and details of the disclosed embodiments herein without departing from the scope of the claimed invention.

What is claimed is:

1. A computer-implemented method for processing definitions within a modeling language, the method comprising:
receiving a context-supported structure definition, the context-supported structure definition defining a context-supported structure;
receiving at least one part definition, each part definition defining a part associated with the context-supported structure;
receiving at least one connector definition, each connector definition defining a connector associated with the context-supported structure; and
receiving at least one constraint definition, each constraint definition defining a constraint for the context-supported structure, wherein the constraint definition is defined via one of the connectors or via one of the parts.

2. The computer-implemented method of claim 1, wherein each part comprises a data member of the context-supported structure.

3. The computer-implemented method of claim 1, wherein at least one of the parts comprises a data member of another context-supported structure.

4. The computer-implemented method of claim 1, wherein one of the connectors connects a new part from another context-supported structure.

5. The computer-implemented method of claim 1, wherein one of the connectors connects two parts each from a different context-supported structure.

6. The computer-implemented method of claim 1, wherein the connector specifies a relationship between instances of class types that are not instances of any part of the context-supported structure.

7. The computer-implemented method of claim 1, wherein the context-supported structure definition, the part definitions, and the connector definitions are declaratively defined.

8. The computer-implemented method of claim 1, wherein the part definition includes an instance number that defines a number of instances of the part which can be instantiated for the associated context-supported structure.

9. The computer-implemented method of claim 1, wherein the connector definition includes a cardinality that defines a number of instances of one part that can be related to a second number of instances of another part.

10. The computer-implemented method of claim 1, wherein the connector definition includes a role definition for each item connected to one of two ends of the connector.

11. A computer-readable storage medium having stored thereon a data structure, the data structure comprising:
a context-supported structure definition, the context-supported structure definition defining a context-supported structure;
at least one part definition, each part definition defining a part associated with the context-supported structure;
at least one connector definition, each connector definition defining a connector associated with the context-supported structure; and
at least one constraint definition, each constraint definition defining a constraint for the context-supported structure, wherein the constraint definition is defined via one of the connector definitions or via one of the part definitions,
wherein during processing, an instance of the context-supported structure is instantiated and becomes associated with at least one instance of each part and at least one instance of each connector in accordance with the at least one constraint.

12. The computer-readable storage medium of claim 11, wherein the at least one part definition defines a type of relationship for the part related to the context-supported structure.

13. The computer-readable storage medium of claim 11, wherein the type defined for two of the parts is different.

14. The computer-readable storage medium of claim 11, wherein the connector definition includes a specification for a relationship with at least one part.

15. The computer-readable storage medium of claim 11, wherein the connector definition includes specification for a relationship between two of the parts.

16. The computer-readable storage medium of claim 11, wherein the context-supported structure definition, the part definitions, and the connector definitions are declaratively defined.

17. The computer-readable storage medium of claim 11, wherein the part definition includes an instance number that defines a number of instances of the part which can be instantiated for the associated context-supported structure.

18. A computing device, comprising:
a processor;
a memory into which a plurality of instructions are loaded, the plurality of instructions performing a method when executed by the processor, the method comprising:
receiving a context-supported structure definition, the context-supported structure definition defining a context-supported structure;
receiving at least one part definition, each part definition defining a part associated with the context-supported structure;
receiving at least one connector definition, each connector definition defining a connector associated with the context-supported structure; and
receiving at least one constraint definition, each constraint definition defining a constraint for the context-supported structure, wherein the constraint definition is defined via one of the connectors or via one of the parts.

19. The computing device of claim 18, wherein the at least one part is related to the context-supported structure through a relationship of a type.

20. The computing device of claim 18, wherein the type for two of the parts is different.
